(19) United States
(12) Patent Application Publication
(10) Pub. No.: US 2011/0317755 A1
(43) Pub. Date: Dec. 29, 2011

(54) SYSTEMS AND METHODS FOR HIGHLY EFFICIENT COMPRESSION OF VIDEO

(75) Inventor: Gregory K. Lancaster, Calgary (CA)

(73) Assignee: Worldplay (Barbados) Inc., Bridgetown (BB)

(21) Appl. No.: 12/822,831

(22) Filed: Jun. 24, 2010

(51) Int. Cl. H04N 7/26

(52) U.S. Cl. 375/240.01; 375/E07.029

(57) ABSTRACT

Compression of video data is achieved by separating the video stream into a high resolution detail stream and a lower resolution carrier stream and by compressing each portion at a rate specific to that portion. By recognizing that the substantial majority of compression defects in a delivered video stream occur in the detail stream, it is possible to capitalize on the relatively high quality of the carrier stream to provide correction information which largely cancels compression defects in the detail stream.

### CROSS-REFERENCE TO RELATED APPLICATIONS

This application is related to commonly owned patent application SYSTEMS AND METHODS FOR HIGHLY EFFICIENT VIDEO COMPRESSION USING SELECTIVE RETENTION OF RELEVANT VISUAL DETAIL, U.S. patent application Ser. No. 12/176,374, filed on Jul. 19, 2008, Attorney Docket No. 54729/P012US/10808779; SYSTEMS AND METHODS FOR DEBLOCKING SEQUENTIAL IMAGES BY DETERMINING PIXEL INTENSITIES BASED ON LOCAL STATISTICAL MEASURES, U.S. patent application Ser. No. 12/333,708, filed on Dec. 12, 2008, Attorney Docket No. 54729/P013US/10808780; VIDEO DECODER, U.S. patent application Ser. No. 12/638,703, filed on Dec. 15, 2009, Attorney Docket No. 54729/P015US/11000742 and concurrently filed, co-pending, commonly owned patent applications A METHOD FOR DOWNSAMPLING IMAGES, U.S. patent application Ser. No. ______, Attorney Docket No. 54729/P017US/11000747; DECODER FOR MULTIPLE INDEPENDENT VIDEO STREAM DECODING, U.S. patent application Ser. No. ______, Attorney Docket No. 54729/P018US/11000748; SYSTEMS AND METHODS FOR CONTROLLING THE TRANSMISSION OF INDEPENDENT BUT TEMPORALLY RELATED ELEMENTARY VIDEO STREAMS, U.S. patent application Ser. No. ______, Attorney Docket No. 54729/P019US/11000749; SYSTEMS AND METHODS FOR ADAPTING VIDEO DATA TRANSMISSIONS TO COMMUNICATION NETWORK BANDWIDTH VARIATIONS, U.S. patent application Ser. No. ______, Attorney Docket No. 54729/P020US/11000750; and SYSTEM AND METHOD FOR MASS DISTRIBUTION OF HIGH QUALITY VIDEO, U.S. patent application Ser. No. ______, Attorney Docket No. 54729/P021US/11000751 all of the above-referenced applications are hereby incorporated by reference herein.

### TECHNICAL FIELD

This disclosure relates to video compression and more specifically to systems and methods for separating the video stream into a detail portion and a carrier portion and by compressing each portion at a data rate specific to that portion.

### BACKGROUND OF THE INVENTION

Compressing video by way of complementary high and low resolution streams leads to difficulties in their reconstitution for display due to the requirement for removing defects from the high resolution stream. In co-pending patent application SYSTEMS AND METHODS FOR HIGHLY EFFICIENT VIDEO COMPRESSION USING SELECTIVE RETENTION OF RELEVANT VISUAL DETAIL there is disclosed a method for generating such complementary streams, the low-resolution stream being generated by downsampling and compressing an original video stream (source video) and the high-resolution stream being derived to provide complementary detail. The detail stream contains defects arising from the compression process, complicating the decode/reconstitution process by requiring detection and removal of such defects.

The detection and removal process is imperfect due to the ambiguity that exists between true compression defects and “defects” which are legitimate image patterns resembling real compression defects. This process is also computationally intensive and expensive to implement in a decoder.

### BRIEF SUMMARY OF THE INVENTION

Compression of video data is achieved by separating the video stream into a high resolution detail stream and a lower resolution carrier stream and by compressing each portion at a rate specific to that portion. By recognizing that the substantial majority of compression defects in a delivered video stream occur in the detail stream, it is possible to capitalize on the relatively high quality of the carrier stream to provide correction information which largely cancels compression defects in the detail stream.

One advantage of this method is that it reduces or eliminates the requirement for detecting and removing detail stream compression defects by including complementary/inverse corrections in the delivered carrier stream. Thus when the carrier and detail streams are recombined in the decoder, the compensation information in the carrier stream largely cancels the compression defects in the detail stream.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows one embodiment of an encoding process in accordance with the concepts of my invention;

FIGS. 2, 3 and 4 show alternate embodiments of the encoder process shown in FIG. 1;

FIGS. 5, 6, 7 and 8 show method flow charts equivalent to FIGS. 1, 2, 3, and 4, respectively illustrating the flow of video through the respective compression processes;

FIG. 9 shows one embodiment of a system using the concepts discussed herein; and

FIG. 10 shows one embodiment of a decoding process suitable for decompressing and recombining the carrier and detail streams delivered from the encoder.

### GENERAL DISCUSSION OF THE INVENTION

In operation, the source video is filtered and downscaled to provide a “clean carrier” video stream. The “clean carrier” stream is upscaled back to the original source video resolution, and subtracted from the original source video to create a “clean detail” stream. The “clean detail” stream is then encoded/compressed to generate a detail stream for delivery.

The encoded “clean detail” stream is also decoded to produce a “recovered detail” stream containing a degraded representation of the “clean detail” stream. The “recovered detail” stream is downscaled to the carrier resolution and subtracted from the “clean carrier” stream to produce a “compensating carrier” stream which is encoded/compressed for delivery. Note that the word “sampling” is used interchangeably with the word “scaling” herein. Thus, downsampling is synonymous with downscaling and upsampling is synonymous with upscaling.

### DETAILED DESCRIPTION OF THE INVENTION

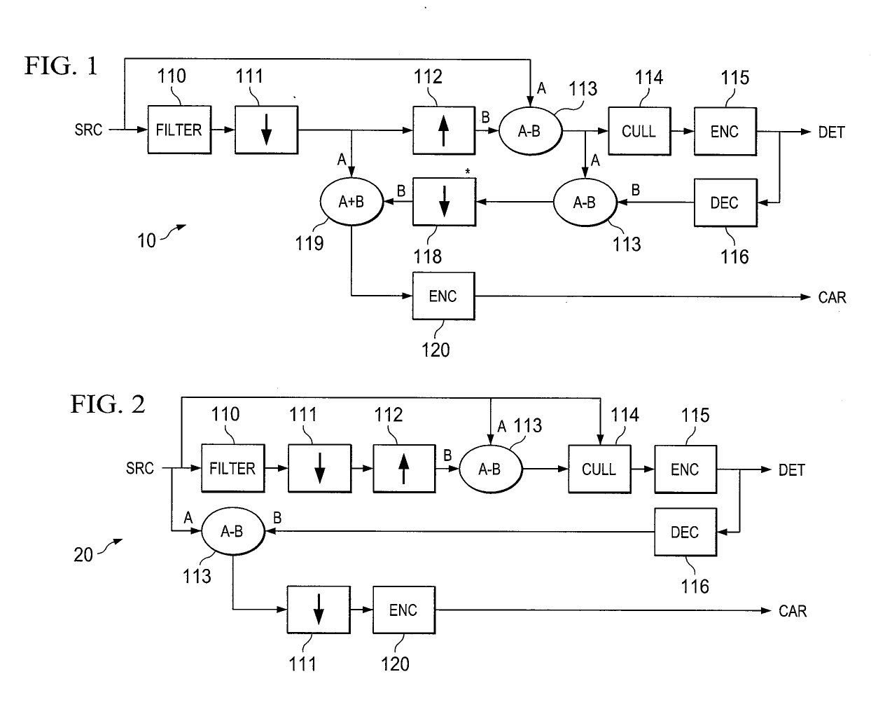

As shown in FIG. 1, source video (src) is the original video to be compressed. Typically the source video will be of high quality (i.e., studio masters, Bluray, 720p or 1080p material, etc.). In some situations the source material may be of lower quality (additive noise, defects due to previous encode/decode cycles or copying) which would cause difficulties (excessive defects and artifacts) when compressed with typical compression algorithms. As will be discussed, the systems and methods presented herein are able to compress both high and low-quality source video to low bitrates with better visual fidelity than typical DCT-based compression methods. Visual fidelity in the present context may be defined as the degree to which decoded video resembles the original source video, such that high fidelity is achieved when a human viewer perceives few or no differences between the original source video and the corresponding compressed/decompressed video. Many measures exist for visual fidelity, and these are termed Objective or Subjective according to whether the measure is derived algorithmically and reproducibly (Objective) or derived from feedback from human viewers (Subjective). Common objective measures include PSNR, SSIM, END, and DMOS. Standards (such as ITU-R BT.500) also exist for subjective testing methods and measures.

The source video is filtered (110-1) to remove high frequency image components such that upon subsequent downsampling to a lower resolution (111-1) the resulting image has minimal aliasing artifacts and is more easily compressed. The strength and type of low-pass filtering applied by (110) is typically adjustable to suit the specific qualities of the source video. Note that the filtering process may be intrinsic to the downsampling process such that both filtering and downsampling are performed inseparably as a single process.

The downsampled video (“clean carrier”) produced by (111-1) is then upsampled to the same resolution as the original source video by (112-1). The upsampling method used here must match the upsampling method to be used later when decoding the final delivered compressed video.

The upsampled video from (112-1) is then subtracted (113-1) from the original source video to produce a “clean detail” video stream. This video stream contains only a high resolution signal containing primarily high-frequency video information (components) of the original source video that are not represented in the clean carrier.

The clean detail video is “culled” (114-1) to remove image elements which would be imperceptible or irrelevant at the desired target quality of the final delivered video. For example, finely-detailed image components that are moving erratically would typically not be perceived by the human visual system (HVS), and may be removed by the culling process (114-1). Typical culling processes are outlined in FIG. 1 of the above-identified SYSTEMS AND METHODS FOR HIGHLY EFFICIENT VIDEO COMPRESSION USING SELECTIVE RETENTION OF RELEVANT VISUAL DETAIL, in elements 14, 15 and 16. Note that the culling process may also result in preferential retention of desirable image components such as facial details by diminishing the strength of less desirable image details. Note also that the culling process may be intrinsic to the encoding process which follows (i.e., some encoders are fairly effective at removing irrelevant detail from the detail stream) in which case the need for additional culling processes such as those referenced above may be reduced or eliminated.

The culled detail video is encoded/compressed by (115-1) to produce the detail video stream for delivery (“delivered detail”).

The “delivered detail” video is decompressed (116-1) to produce a “recovered detail” stream which contains defects and artifacts resulting from compression process (115-1).

The recovered detail stream is subtracted (113-11) from the clean detail video to produce a “compensation” video stream. This compensation stream will contain the sum of the culled detail image components and a negative representation of the image errors produced by the compression/decompression (115-1/116-1) process. The properties of this stream are such that if it were added to a decompressed version of the delivered detail stream, the culled image details would be restored and the compression/decompression errors would be cancelled. As will be described below, this compensation video stream will be incorporated in reduced and compressed form into the “compensating carrier” stream to be compressed and delivered, such that it approximately compensates the errors and culled details in the delivered detail video.

The compensation video stream is then downsampled (118-1) to the same resolution as the clean carrier stream.

The downsampled compensation stream is added (119-1) to the clean carrier stream to produce a “compensating carrier” video stream. This stream now contains the low-frequency components of the original source video plus a downsampled representation of culled video components plus a downsampled negative representation of the compression errors in the delivered detail stream.

The compensating carrier video stream is then compressed (encoded) (120-1) to produce the final carrier stream to be delivered (the “delivered carrier”). This compression is performed with high fidelity to minimize the introduction of additional compression errors. To achieve the desired fidelity in the carrier stream, the stream is often compressed at a higher bitrate than the delivered detail stream. For example, with some source video the best fidelity of the reconstructed video to be presented to the viewer is achieved by allocating 80 percent of total compressed video bitrate to the carrier stream and 20 percent to the detail stream. The optimum allocation is variable, and may change from time to time within any particular video stream. It is possible to achieve higher fidelity by dynamically adjusting the relative bitrates allocated to carrier and detail streams according to measured characteristics of the source video such as contrast and motion complexity.

The following glossary provides details of one embodiment of the various elements. Note that the same basic element number (the number before the dash in the FIGURES) in different FIGURES equates to the same element. Thus filter 110-1 operates the same as does filter 110-2.

Filter 110:

A low-pass filter intended to remove high spatial frequency components of a video stream. Possible filter implementations may include gaussian filters, sinc filters, or filters with arbitrarily constructed pass-bands (e.g., as might be achieved with an FFT/inverse FFT combination). In some cases, this filter stage is intrinsic to the downsampling process (111) such that they are not separated. The primary purpose of the low-pass filtering is to reduce image components which would produce aliasing artifacts upon subsequent downsampling of the video and improve the compressibility of such downsampled video.

Downsampler 111:

The downsampler produces a lower-resolution representation of an input video. Many applicable downsampling methods exist (bilinear interpolation, bicubic interpolation, Lanczos methods, etc.), and in general a higher-quality/higher-order method is desirable for optimum final quality of the overall compression process. The highest quality methods are computationally expensive, so a lower-quality method may be chosen to improve overall process efficiency. The optimum downsampling ratio (i.e., to achieve optimum fidelity in the final decoded video) can vary depending upon the characteristics of the input video, and is typically in the range of ⅜ to ¾ of the input video resolution though it may sometimes be as low as ⅛. It is also possible that optimum resampling may use different ratios in the horizontal and vertical image dimensions (e.g., ⅜ resolution in the horizontal dimension and ½ resolution in the vertical dimension). The downsampling ratio chosen may vary from time to time within a given video in order to optimize final quality. Note that the downsampler may be implemented as a multi-tap filter itself, such that it intrinsically incorporates the filtering component (110) or it may use the process shown in downsampler 118.

Upsampler 112:

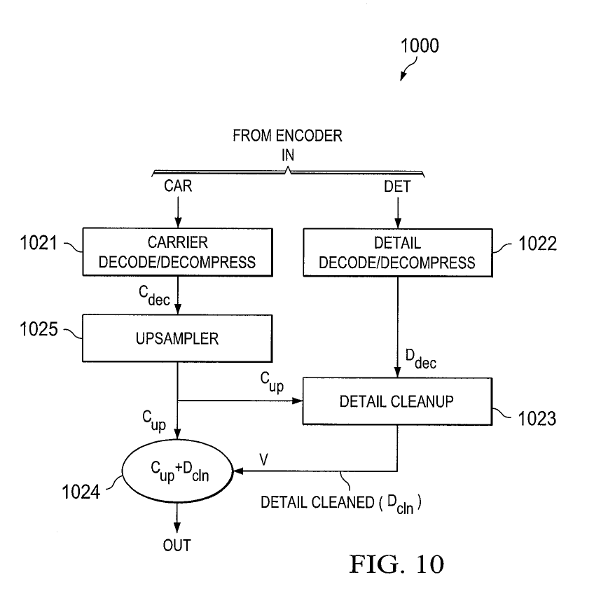

The upsampler produces a higher-resolution representation of an input video. In the current application, the upsampling ratio is chosen to be the inverse of the downsampling ratio in (111), such that the output video resolution is the same as the original source video. Many upsampling methods exist (the list is similar to that of downsampling methods), but the chosen method for this specific component should (for optimal quality) match the upsampling method used in the decoder (process 1025 in FIG. 10) for recombining the final decompressed video for viewing. For example, this element of the encoder and the corresponding element of the decoder may both use bicubic resampling to balance quality and cost. The method may be fixed for a given embodiment, or it may be allowed to vary (for optimal quality), in which case the specification for the upsampler should be communicated to the decoder such that it can use the same specification for upsampling. It is also possible to use structure-sensitive upsampling/upscaling methods such as edge-directed interpolation, which effectively detects edge-like features in the low-resolution input and produces sharp corresponding edges in the higher-resolution output with fewer aliasing artifacts than conventional content-agnostic upsampling techniques. To the extent that the upsampling/upscaling method is able to more accurately reproduce a high resolution version of the video without introducing erroneous high-resolution artifacts, overall fidelity may be improved because the amount of information in the high-resolution detail stream (i.e., the difference between the original high-resolution source video and the corresponding upsampled/upscaled carrier stream) is reduced and may be compressed/encoded more accurately.

Video Subtraction with Saturation 113:

This component performs the pixel-to-pixel subtraction of one video from another of identical resolution. Typical video encoding uses a limited number of bits per pixel, and may split the representation of a pixel into several numbers (e.g., luma Y/chroma U/chroma V, or Red/Green/Blue). These numbers are typically limited to positive values with a limited range (e.g., 0-255), so representing the results of a subtraction requires an offset such that negative results have a valid video representation. Thus “saturating” arithmetic is used when pixel component values are subtracted: Yout=(YinA−YinB)+128, truncated to the range 0-255. This process can potentially lose information if the two input pixels are very different, but this is very rarely the case in the current application.

Detail Culling 114:

One embodiment of detail culling is shown in above-identified patent application titled SYSTEMS AND METHODS FOR HIGHLY EFFICIENT VIDEO COMPRESSION USING SELECTIVE RETENTION OF RELEVANT VISUAL DETAIL (herein, the Reference) Processes 14, 15 and 16 (shown in Reference FIG. 1) pertain to selective detail suppression applied to the detail video data to eliminate imperceptible or otherwise irrelevant detail to produce a “trimmed” detail stream. The detail suppression processes generate suppression coefficients corresponding to areas of the detail stream to be suppressed or retained.

An example detail-suppression method is represented by Reference process 16 in which the source video is analyzed via conventional motion-estimation techniques to find the location and magnitude of motion in the original video in order to determine areas where the magnitude of the motion begins to approach the response rate limits of the HVS. In areas where little or no motion is detected, the suppression coefficients are set to preserve the corresponding detail stream areas (no suppression). In areas where the motion velocity exceeds the HVS response rate limits, the suppression coefficients are set to eliminate the corresponding detail stream areas (full suppression). Motion magnitudes between these limits result in coefficients signaling partial suppression of the corresponding detail stream areas, varying from no suppression to full suppression according to the magnitude.

Note that the motion estimates required for the above process may be derived in many ways. For example, motion estimates may be obtained from the carrier encoder, if the encoder is a block-based encoder that uses motion estimation internally. This has the practical effect of reducing the amount of encode time spent doing motion estimation, but is not strictly required.

Other detail management/suppression methods, such as facial recognition Reference 15, de-emphasizing peripheral area details, or emphasis/de-emphasis of other regions of known HVS sensitivity/insensitivity, or of relative interest/disinterest can also be used alone or in combination, each supplying suppression coefficients to be applied to the detail stream by Reference process 17 which can be any one of may well-known processes for applying suppression coefficients to preserve or eliminate detail areas. One such process involves simple multiplication of detail values by suppression coefficients represented as spatially-varying scalar values ranging from 0.0 to 1.0. In areas where detail is to be fully suppressed, the corresponding suppression coefficient value is 0.0, while areas where detail is to be fully preserved have a corresponding suppression coefficient of 1.0. Partial suppression is achieved by coefficient values greater than 0.0 and less than 1.0. The nature of the detail data (zero-centered values of generally low magnitude) is well suited to allow simple suppression of this type. An alternate suppression method could perform quantization of the detail stream data such that areas to be fully preserved are quantized very finely (i.e., fully preserving luminance and chrominance accuracy), while areas to be suppressed are quantized more coarsely according to the level of suppression. In this case, the most coarsely quantized detail values are set to zero.

In some situations (such as single-pass video encoding for bandwidth-limited channels), it is desirable to limit the bitrate of the encoded detail stream. In one embodiment, after the detail video stream has been “trimmed” by Reference process 18 but before encoding, an estimate can be made for each frame being processed as to what the compressed/encoded output size is likely to be. For most encoding methods, this can be estimated with fair accuracy (˜15%). Given this estimate, the system can retroactively adjust the amount of data to be encoded such that the target bitrate is better achieved. The zero-centered form of the detail data is such that detail suppression methods can easily be applied. These can be the same detail suppression methods described above to eliminate (or otherwise render more compressible) lower-priority portions of the details.

Encoder/Compressor 115:

This element is a conventional video compressor, typically using a DCT-based method such as H.264, MPEG4 part 2, or MPEG2. For compressing the detail stream this compressor is configured to produce a much higher compression ratio than is typically used for standard video. This succeeds because the characteristics of the detail stream being compressed (limited low-frequency content, extraneous detail culled) substantially reduce the occurrence of the most visible kinds of artifacts which typically result from extreme video compression. For example, a detail stream might be encoded at a compression level of less than 0.01 bits per pixel. In addition, the artifacts which are produced in the delivered detail stream tend to be of a nature that can be largely compensated by correction information in the high-fidelity carrier stream. Note that the encoder itself may intrinsically produce a detail-culling effect at high compression ratios (i.e., chaotic motion and low-contrast details may be reduced or eliminated), and some effective implementations may be constructed without a separate detail culling stage such as that described above.

Decoder/Decompressor 116:

This element is complementary to the encoder/compressor (115), such that it is capable of decoding the type of stream produced by that compressor. The output of this component is a video stream in uncompressed form compatible with the other processing elements such as the subtraction/addition components (e.g., 113, 119).

Correction Downsampler 118:

This downsampler is similar in operation to (111), producing a reduced-resolution video from an input video. However, the limited nature of the video data being downsampled here (i.e., correction information, typically sparse detailed variations on a “mid-grey” background) allows the use of specialized downsampling algorithms that may not be as applicable to general video content. Specifically, an “inverse upscaling” or “iterative downscaling” component described in the above-identified patent application entitled “A METHOD FOR DOWNSAMPLING IMAGES” has been found to be very effective in this application (although any high-quality downsampling method may work). The downsampling component is configured to produce a resolution matching that of the carrier video produced by (111).

Video Addition with Saturation 119:

Complementary to element 113, this component performs pixel-wise addition of two input video streams. One of the input streams is typically a “difference” stream produced by or derived from the output of a video subtraction element. For each pair of corresponding pixels from the two inputs, the pixel components (Y/U/V or R/G/B) a computed via saturating addition: Yout=YinA+YinB−128, truncated to the representable range of the output pixel components (typically 0-255).

Encoder/Compressor 120:

This element is a conventional video compressor, typically using a DCT-based method such as H.264, MPEG4 part 2, or MPEG2. For compressing the carrier stream this compressor is configured to produce a high-fidelity result with a relatively high bits-per-pixel content (e.g., typically>0.1 bits per pixel for H.264). This bits-per-pixel value will not cause a correspondingly high bits-per-pixel number for the final reconstructed higher-resolution video (detail+upsampled carrier streams) because the number of pixels in the carrier is relatively low (source video pixels×horizontal downsampling ratio×vertical downsampling ratio).

FIG. 2 shows a second embodiment 20 in which the source video (src) is filtered (110-2) to remove high frequency image components such that upon subsequent downsampling to a lower resolution (111-2) the resulting image has minimal aliasing artifacts and is more easily compressed. As described for embodiment 10, the strength and type of filtering applied may be varied to suit the characteristics of the video being encoded, and the filtering may actually be intrinsic to the subsequent downsampling step described below.

The downsampled video (“clean carrier”) produced by (111-2) is then upsampled to the same resolution as the original source video by (112-2). As discussed above, the upsampling method used here must match the upsampling method to be used later when decoding the final delivered compressed video.

The upsampled video from (112-2) is then subtracted (113-2) from the original source video to produce a “clean detail” video stream. This video stream contains only the high-frequency video components of the original source video that are not represented in the clean carrier.

The clean detail video is “culled” (114-2) to remove image elements which would be imperceptible or irrelevant at the desired target quality of the final delivered video.

The culled detail video is encoded/compressed by (115-2) to produce the detail video stream for delivery (“delivered detail”). As discussed previously, the culling process may also be intrinsic to the subsequent encoding/compression process below.

The culled detail encoded video is decompressed (116-2) to produce a “recovered detail” stream which contains defects and artifacts resulting from compression process (115-2).

The recovered detail video is subtracted (113-21) from the original video stream to produce a “compensating reduced-detail stream”. In this stream, accurately-delivered details have been removed so that they will not be included in the carrier stream to be generated. In addition, inaccuracies in the delivered detail stream (defects and artifacts) are incorporated in negative form. Thus the nature of this stream is such that if it were added to a recovered detail stream (i.e. such as will be generated in the final decode process), a perfect reproduction of the original source video would be produced. The compensating reduced-detail stream is then downsampled (111-21) and then compressed (encoded) (120-2) to produce the final carrier stream to be delivered (the “delivered carrier”).

The overall effect achieved by embodiment 20 in FIG. 2 is similar to that achieved in embodiment 10 in FIG. 1. The delivered detail will be identical, while the delivered carrier stream will differ slightly due to the way in which defect/artifact corrections are incorporated. Embodiment 20 will in general convey less precise compensation information in the carrier stream, but the carrier stream will be more compressible and thus may be compressed to a lower bitrate without introducing noticeable defects and artifacts in the delivered carrier stream itself.

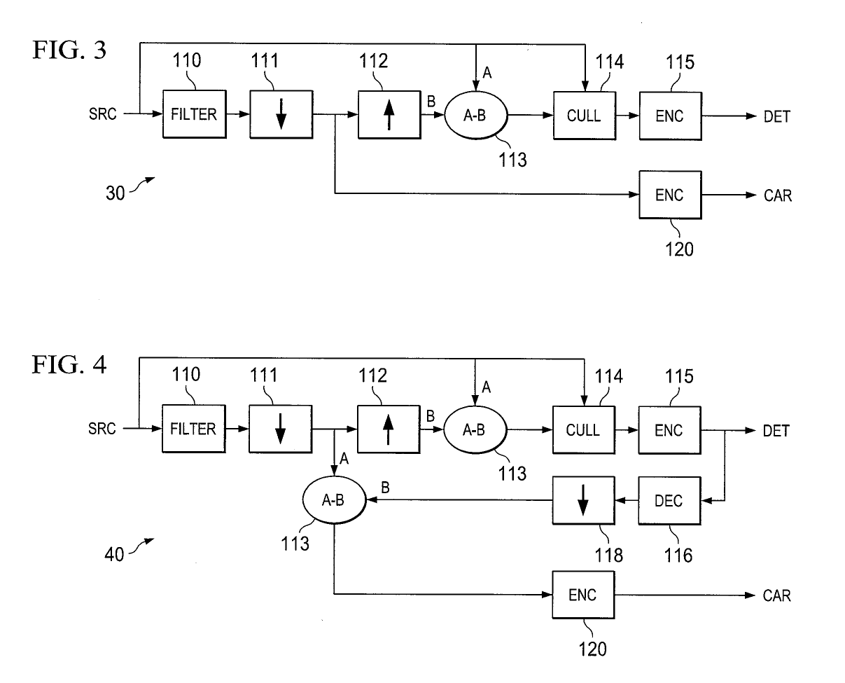

FIG. 3 shows a third embodiment 30 in which the source video (src) is filtered (110-3) to remove high frequency image components such that upon subsequent downsampling to a lower resolution (111-3) the resulting image has minimal aliasing artifacts and is more easily compressed. As described for embodiment 10, the strength and type of filtering applied may be varied to suit the characteristics of the video being encoded, and the filtering may actually be intrinsic to the subsequent downsampling step described below.

The downsampled video (“clean carrier”) produced by (111-3) is then upsampled to the same resolution as the original source video by (112-3). As discussed above, the upsampling method used here must match the upsampling method to be used later when decoding the final delivered compressed video.

The upsampled video from (112-3) is then subtracted (113-3) from the original source video to produce a “clean detail” video stream. This video stream contains only the high-frequency video components of the original source video that are not represented in the clean carrier.

The clean detail video is “culled” (114-3) to remove image elements which would be imperceptible or irrelevant at the desired target quality of the final delivered video. As discussed previously, the culling process may also be intrinsic to the subsequent encoding/compression process below.

The culled detail video is encoded/compressed by (115-3) to produce the detail video stream for delivery (“delivered detail”).

The “clean carrier” stream produced by (113-3) is then compressed (encoded) (120-3) to produce the final carrier stream to be delivered (the “delivered carrier”).

The encoding performed by embodiment 30 in FIG. 3 differs from that in embodiments 10 and 20 in that no compensation information is incorporated into the delivered carrier stream. This reduces implementation and computational cost when the target encode bitrates are high enough that artifacts in the detail stream are minimal. Visual fidelity achieved by this encoding method is still generally higher than that produced directly by conventional DCT-based encode methods at equivalent high compression ratios.

FIG. 4 shows a fourth embodiment 40 in which the source video (src) is filtered (110-2) to remove high frequency image components such that upon subsequent downsampling to a lower resolution (111-2) the resulting image has minimal aliasing artifacts and is more easily compressed. As described for embodiment 10, the strength and type of filtering applied may be varied to suit the characteristics of the video being encoded, and the filtering may actually be intrinsic to the subsequent downsampling step described below.

The downsampled video (“clean carrier”) produced by (111-4) is then upsampled to the same resolution as the original source video by (112-4). As discussed above, the upsampling method used here must match the upsampling method to be used later when decoding the final delivered compressed video.

The upsampled video from (112-4) is then subtracted (113-4) from the original source video to produce a “clean detail” video stream. This video stream contains only the high-frequency video components of the original source video that are not represented in the clean carrier.

The clean detail video is “culled” (114-4) to remove image elements which would be imperceptible or irrelevant at the desired target quality of the final delivered video. As discussed previously, the culling process may also be intrinsic to the subsequent encoding/compression process below.

The culled detail video is encoded/compressed by (115-4) to produce the detail video stream for delivery (“delivered detail”).

The culled detail encoded video is decompressed (116-4) to produce a “recovered detail” stream which contains defects and artifacts resulting from compression process (115-4).

The recovered detail video is downsampled (118-4) and then subtracted (113-41) from the clean carrier video stream. This incorporates a negative approximation of the detail stream defects and artifacts into the carrier, creating a compensating carrier stream. This stream is then compressed (encoded) (120-4) to produce the final carrier stream to be delivered (the “delivered carrier”).

The overall effect achieved by the embodiment 40 in FIG. 4 is similar to that achieved by embodiment 20 in FIG. 2. The primary difference is that defects and artifacts in the detail stream are downsampled before being recombined with the clean carrier to produce a compensating carrier, rather than being recombined directly with the source video before downsampling to produce a compensating carrier. Thus the encodes from embodiment 40 tend to have slightly sharper carrier streams and thus sharper final reconstructed video at low bitrates, but at a higher risk of aliasing and carrier compression artifacts.

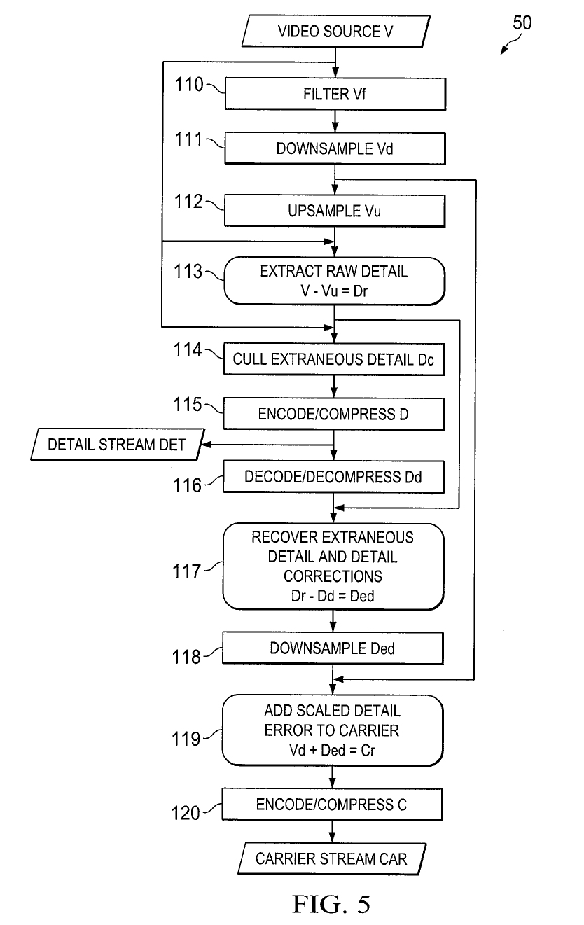

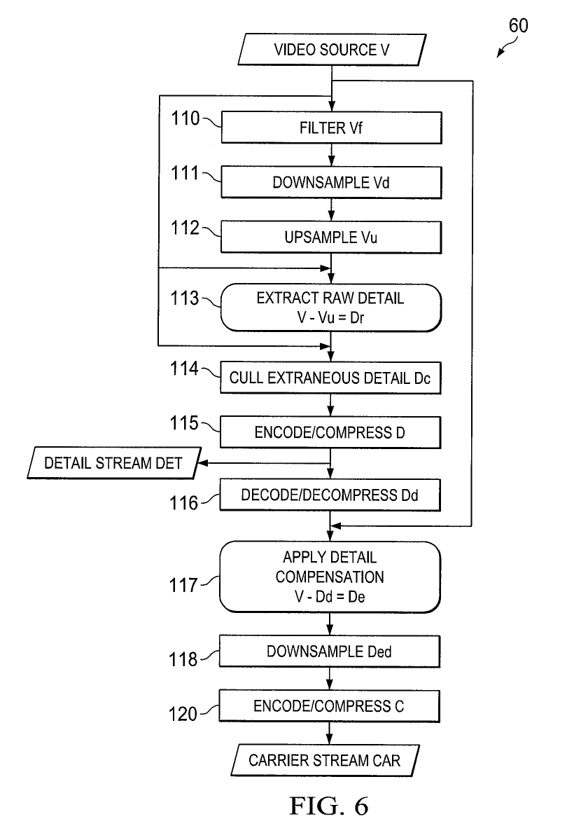

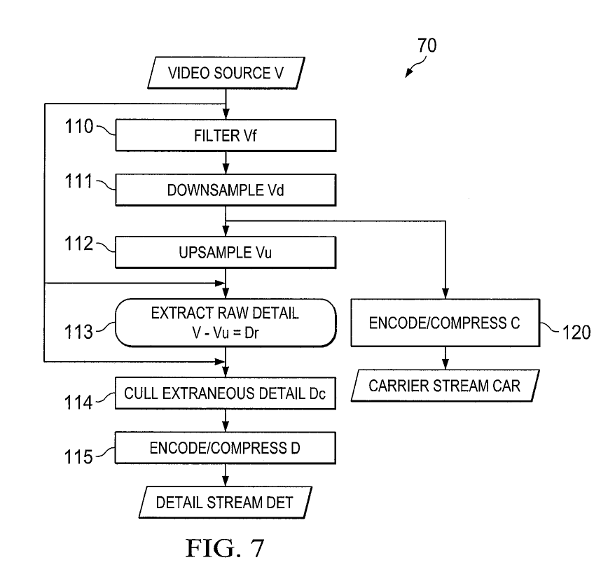

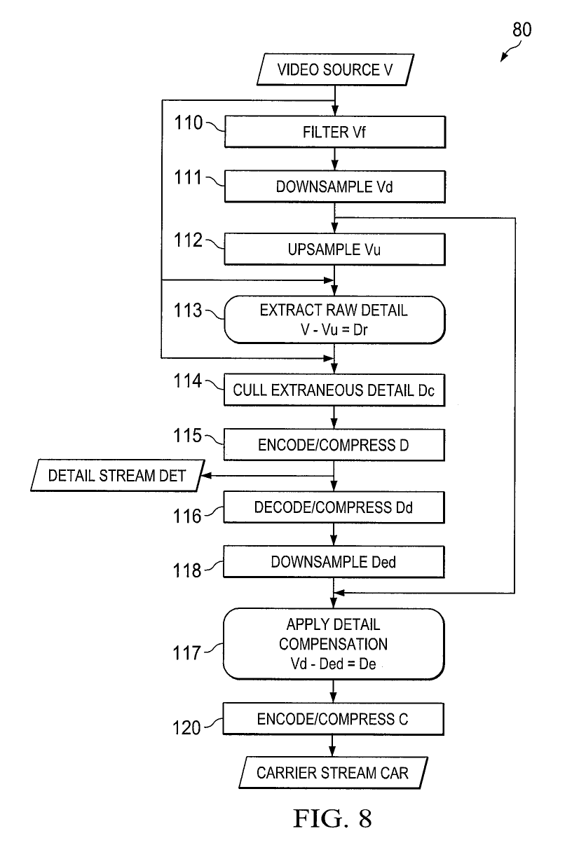

FIGS. 5, 6, 7 and 8 show method flow charts 50, 60, 70 and 80 equivalent to FIGS. 1, 2, 3, and 4, respectively, to illustrate the flow of video through the respective compressors. Note that in FIGS. 5-8 the numbers of the respective processes reflect the apparatus numbers from FIGS. 1-4 and add brief process descriptions to assist in understanding the compression process.

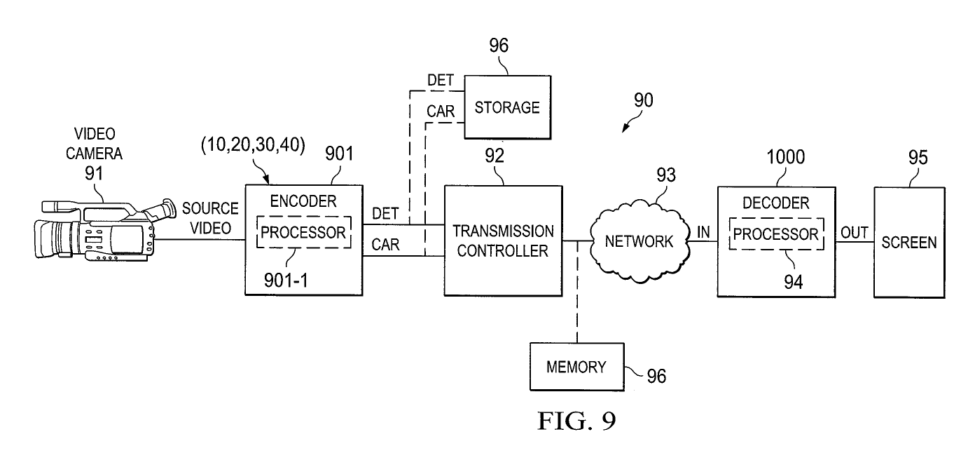

FIG. 9 shows one embodiment of a system, such as system 90, using the concepts discussed herein. The source video in this example comes from video camera 91 but it could come from a DVD, or from a transmission from any other location. The source video arrives at encoder 901 (which could be configured as shown by systems 10, 20, 30, 40 or other embodiments of the present invention) at a bitrate typically around 10 MBits/sec or higher. The encoder, following the concepts discussed herein and utilizing a processor such as processor 901-1 or equivalent hardware components, compresses the accepted input video stream into a low-bitrate data transmission stream. This compressed output data stream is comprised of two video streams called the detail stream and the carrier stream. Transmission control 92 then combines the compressed detail and carrier streams, along with the audio, into a single packetized stream for delivery to locations remote from the encoder. Note that the compressed video may, instead of being delivered remotely can be stored in a memory, such as memory 96 which can be local to encoder 10, or remote therefrom. One embodiment for transmission controller 92 is detailed in above-identified patent application titled ELEMENTARY STREAM FORMAT FOR DUAL H264 STREAMS.

Alternately, instead of transmitting the DET and CAR compressed video streams to a remote location, they can be “transmitted” locally for storage, either individually as DET and CAR streams or in combined format, in storage, for example, in storage 96 or on a local hard drive, flash drive or even a low capacity CD. At some future time the compressed video signals can be removed from storage and transmitted (or locally decoded) as will be discussed below.

One result of the systems and methods contained herein is the ability to deliver to an end user a visually pleasing 1080p high-definition video stream using a transmission medium of 3 mbps or less assuming the video content is typical of broadcast video. Note that the required bitrate (for given fidelity) is strongly dependent on the resolution and visual content of the video to be encoded.

The output from transmission control 92 is then delivered, for example by network 93 to remotely located decoder 1000. Decoder 1000, using hardware components and/or a processor, such as processor 94, then decompresses the video to reproduce an output having high fidelity with respect to the video from the original video source. The reproduced video is then available for presentation, for example, on screen 95 which can be a TV screen or a computer monitor or for further transmission. One embodiment for decoder 1000 is detailed in above-identified patent application titled DECODER FOR MULTIPLE INDEPENDENT VIDEO STREAM DECODING. Using such a decoder, the “Detail Cleanup” process should be considered an optional component (or one that can be “turned down” to have minimal or no effect).

A preferred embodiment is shown in FIG. 10 which accepts the CAR and DET streams generated as discussed above with respect to FIG. 1, 2, 3 or 4. Process 1021 decompresses the CAR stream and process 1022 decompresses the DET stream. Process 1025 upsamples the decompressed CAR stream to the same resolution as the decompressed DET stream and, if desired, could be the exact same as process 112 (FIG. 1).

One decoder embodiment could just add the upsampled decoded carrier and the detail stream (and subtract out the (e.g.) 128 offset that may have been applied for encoding), resulting in a displayable video stream. This is a preferred approach for encodes that do not exhibit a significant ‘haze’ artifact (which arises from excessive compression artifacts in the detail stream). However, for those situations where higher compression has caused a perceptible ‘haze’ effect, an additional cleanup process, such as process 23, may be applied.

Process 1023 examines both the decoded detail D_{dec} and upsampled decoded carrier Cᵤₚ frames to find copied detail macroblocks that result in the haze effect. There are many possible embodiments of such a process, but the central idea is to use information from the reliable high fidelity carrier stream to determine where the lower-fidelity detail stream information is incorrect or unreliable. A preferred embodiment of process 1023 consists of a series of tests as described below. These tests are applied to blocks of pixels in the detail video frames and the corresponding pixels of the carrier video frames. If the tests determine that the block is ‘haze’, its contents are nullified (i.e., there is no detail, and only the carrier is retained in the corresponding location). Note that the blocks to which these tests are applied should be chosen according to the DCT-based encode/decode method used for the detail stream. If the method marks only entire macroblocks as being copied, then the blocks tested here should correspond directly to those macroblocks. If the method allows for partitioning macroblocks into sub-blocks that can be marked individually for copying, the blocks tested here should correspond to the sub-blocks.

It is possible for the results of a block test to be inconclusive as well. To deal with this situation, the results of the ‘haze test’ are retained from frame to frame. If a block was assessed to be ‘haze’ on the previous frame and the test on the current frame is inconclusive, we retain the previous assessment and assume that the block is haze on this frame as well. Similarly, if the block was not haze on the previous frame, the same assessment is retained if the test for the current frame is inconclusive. For the very first frame in a video sequence, it is assumed that all details are valid (and the ‘haze state’ for every block defaults to ‘not haze’).

The tests require access to both the current carrier and detail video frames and to the immediately previous carrier and detail frames (for change detection). The tests are as follows (execute for each block):

1) If the detail block contents were not copied from the previous frame, the block is not haze (end test). Note that the determination of whether the contents were copied may be explicit or implicit: it may be possible to obtain the ‘copy flags’ directly from the decoder, or alternately the detail block contents may be compared between frames with the assumption that an exact match implies that the detail block was copied.

2) If the standard deviation of the detail block contents is too high (i.e., strongly textured), the block is most likely not haze (end test). Most ‘haze’ blocks are completely flat (i.e., standard deviation of zero): high energy in the block tends to imply that it is not an artifact. In addition, true ‘haze’ is less obvious in areas where the image has a lot of natural texture so even if we miss some haze due to this rule it is likely to be obscured. The ‘high’ threshold is specified as a decoder control parameter. A typical ‘high’ threshold value that has been found to work in practice is approximately 1% of the total available brightness range.

3) If the mean value of the detail block contents is ‘too far’ from zero, it has too much energy to be considered to be haze (end test). The ‘too far’ threshold is specified as a decoder control parameter. A typical mean value that has been found to work in practice is approximately 4% of the total available brightness range.

4a) If the carrier pixel corresponding to the current block have on average changed ‘significantly’ since the last frame, then the block most likely is ‘haze’ and should be nullified (end test). The ‘significantly’ threshold is specified as a decoder control parameter. A typical ‘significantly’ threshold value that has been found to work in practice is approximately 0.5% of the total available brightness range.

4b) If motion estimation on the carrier indicates that the image in the vicinity of the current block is moving, then the block most likely is ‘haze’ and should be reset to zero (end test). Note that this test may be prohibitive for inexpensive decoder hardware, and therefore may be considered optional.

5) Test was ambiguous: neither carrier nor detail has changed, and energy is fairly low. Reuse the assessment result from the previous frame.

Process 1024 sums the upscaled decoded CAR stream Cᵤₚ and the ‘de-hazed’ (i.e., cleaned) detail stream to produce the final reconstructed output.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for reducing the bandwidth requirement for delivering a digital video signal from a source to a destination, said method comprising:
downsampling an accepted digital video signal from a source;
subtracting said downsampled signal from said accepted digital video signal to form a high resolution signal containing primarily high frequency video information of said accepted digital video signal;
encoding said high resolution signal for transmission;
forming a signal having relatively low resolution components of said accepted digital video signal; and
encoding said low resolution signal for transmission in conjunction with said encoded high resolution component signal.

2. The method of claim 1 wherein a combined transmission bandwidth of said encoded high frequency resolution signal and said low resolution signal is less than a bandwidth typically required to transmit said accepted digital video signal with acceptable visual fidelity.

3. The method of claim 2 wherein said combined bandwidth is below 5 MBits/sec.

4. The method of claim 2 wherein said combined bandwidth is at or below 2 MBits/sec.

5. The method of claim 1 further comprising culling extraneous detail from said high resolution signal prior to, or in concert with, encoding said high resolution signal.

6. The method of claim 5 wherein said culling results in preferential retention of desirable image components.

7. The method of claim 5 wherein said forming comprises:
decoding said encoded high resolution signal;
subtracting said last-mentioned decoded signal from said high resolution signal prior to said high resolution signal being culled;
downsampling said last-mentioned subtracted signal; and
adding said last-mentioned downsampled signal to said downsampled signal from said accepted digital video signal.

8. The method of claim 1 wherein said forming comprises:
decoding said encoded high resolution signal;
subtracting said decoded signal from said accepted digital video signal; and
downsampling said last-mentioned subtracted signal.

9. The method of claim 1 wherein said forming comprises:
directly using said downsampled signal from said accepted digital video signal for said encoding.

10. The method of claim 1 wherein said forming comprises:
decoding said encoded high resolution signal;
downsampling said last-mentioned decoded signal; and
subtracting said last-mentioned downsampled signal from said downsampled signal from said accepted digital video signal.

11. The method of claim 1 further comprising:
low-pass filtering said accepted digital video signal prior to said downsampling.

12. A method of compressing video data, said method comprising:
downsampling an accepted digital video signal;
subtracting said downsampled signal from said accepted digital video signal to form a signal having high resolution components of said accepted digital video signal;
encoding at a first rate said high resolution component signal for transmission, said encoding thereby introducing defects in said high resolution component signal;
forming a signal having lower resolution components of said accepted digital video signal;
encoding at a second rate said lower resolution component signal in conjunction with said encoded high resolution component signal for transmission.

13. A method of claim 12 wherein said second rate is higher than said first rate.

14. A method of claim 13 wherein said forming comprises:
extracting extraneous detail from said high resolution component signal.

15. A method of claim 14 wherein said lower resolution component signal comprises:
said extraneous detail extracted from said high resolution component signal; and
a negative representation of said defects introduced by encoding said high resolution component signal.

16. The method of claim 13 wherein a combined transmission bandwidth of said encoded high resolution component signal and said low resolution signal is less than a bandwidth required to transmit said accepted digital video signal.

17. The method of claim 16 wherein said combined bandwidth is below 5 MBits/sec.

18. The method of claim 16 wherein said combined bandwidth is at or below 2 MBits/sec.

19. The method of claim 14 wherein said extracting comprises:
culling extraneous detail from said high component signal prior to said encoding of said high frequency component signal;
decoding said encoded high component signal, thereby introducing defects in said high component signal;
subtracting said last-mentioned decoded signal from said high component signal prior to said high component signal being culled;
downsampling said last-mentioned subtracted signal; and
adding said last-mentioned downsampled signal to said downsampled signal from said accepted digital video signal.

20. The method of claim 12 wherein said forming comprises:
decoding said encoded high component signal;
subtracting said decoded signal from said accepted digital video signal; and
downsampling said last-mentioned subtracted signal.

21. The method of claim 12 wherein said forming comprises:
directly using said downsampled signal from said accepted digital video signal for said encoding.

22. The method of claim 12 wherein said forming comprises:
decoding said encoded high component signal;
downsampling said last-mentioned decoded signal; and
subtracting said last-mentioned downsampled signal from said downsampled signal from said accepted digital video signal.

23. The method of claim 12 further comprising:
low-pass filtering said accepted digital video signal prior to said downsampling.

24. A method of claim 19 wherein said lower resolution signal comprises:
a negative representation of said defects introduced by said decoding of said high component signal.

25. A video compression process comprising:
means for accepting a source digital video stream;
means for separating from an accepted video stream a first encoded video stream containing a detail portion of said accepted source video stream; and
means for using said first encoded video stream for separating from said accepted video stream a second encoded video stream containing a carrier portion of said accepted source video stream.

26. The compression process of claim 25 wherein said first stream separating means comprises:
a downsampler process for generating a first reduced pixel data stream from said accepted video stream;
an upsampler process for recreating a full pixel data stream from said first reduced pixel data stream;
a subtraction process for subtracting said recreated upsampled data stream from said accepted data stream;
an encoder process for compressing an output of said subtraction process thereby generating said first encoded video stream.

27. The compression process of claim 26 further comprising:
a culling process interposed between said subtraction process and said encoding process.

28. The compression process of claim 27 wherein said second stream separation means comprises:
a decoding process for decoding said first encoded video stream to form a decoded output signal stream;
a subtracting process for generating a difference signal stream between said input to said culling process and said decoded output signal stream;
a downsampling process for downsampling said difference signal stream;
an adding process for adding an output signal stream from said last-mentioned downsampling process and said first reduced data pixel stream; and
an encoding process for compressing an output of said adding process to form said second encoded video stream.

29. The compression process of claim 27 wherein said second stream separation means comprises:
a decoding process for decoding said first encoded video stream to form a decoded output signal stream;
a subtracting process for generating a difference signal stream between said accepted video stream and said decoded output signal stream; and
an encoding process for compressing an output of said adding process to form said second encoded video stream.

30. The compression process of claim 27 wherein said second stream separation means comprises:
an encoding process for compressing said first reduced pixel data stream to form said second encoded video stream.

31. The compression process of claim 27 wherein said second stream separation means comprises:
a decoding process for decoding said first encoded video stream to form a decoded output signal stream;
a downsampling process for generating a second reduced pixel data stream from said decoded output signal stream;
a subtracting process for generating a difference signal stream between said first reduced pixel data stream and said second reduced pixel data stream; and
an encoding process for compressing an output of said adding process to form said second encoded video stream.

32. A system for video stream compression, said system comprising:
a processor for separating from an accepted video stream a first encoded video stream containing a detail portion of said accepted source video stream; and
said processor further operable for using said first encoded video stream for separating from said accepted video stream a second encoded video stream containing a carrier portion of said accepted source video stream; and
a transmission controller for sending both said first and second encoded video streams to a remote location in compressed format requiring bandwidth under 5 MBits/sec. while still achieving a high fidelity reproduction of said accepted video stream after decompression of said compressed format.

33. The system of claim 32 wherein said compressed format requires bandwidth of under 3 MBit/sec while still achieving a high fidelity reproduction of said accepted video stream after decompression of said compressed format.

34. The system of claim 32 further comprising:
a decoder for decompressing said compressed format to achieve said high fidelity reproduction of said accepted video stream.

35. The system of claim 34 further comprising:
a display for displaying said high fidelity reproduction of said accepted video even though said reproduction is missing data representing certain details.

36. The system of claim 35 wherein said certain missing details pertain to at least one of the following: fast-moving details, peripheral details, and non-facial details.

37. The system of claim 32 further comprising:
a storage device for storing said first and second encoded video streams.

38. A system for video stream compression, said system comprising:
a processor for separating from an accepted video stream a first encoded video stream containing a detail portion of said accepted source video stream; and
said processor further operable for using said first encoded video stream for separating from said accepted video stream a second encoded video stream containing a carrier portion of said accepted source video stream; and
a storage device for storing said first and second encoded video streams.

39. The system of claim 38 wherein said first and second video streams are stored in said storage device in compressed format requiring bandwidth under 5 MBits/sec. while still achieving a high fidelity reproduction of said accepted video stream after decompression of said compressed format.

40. The system of claim 38 wherein said first and second video streams are stored in said storage device in compressed format requiring bandwidth under 3 MBits/sec. while still achieving a high fidelity reproduction of said accepted video stream after decompression of said compressed format.

41. The system of claim 38 further comprising:
a transmission controller for sending both said first and second encoded video streams from said storage device to a remote location in compressed format requiring bandwidth under 5 MBits/sec. while still achieving a high fidelity reproduction of said accepted video stream after decompression of said compressed format.

42. The system of claim 41 wherein said compressed format requires bandwidth of under 3 MBit/sec while still achieving a high fidelity reproduction of said accepted video stream after decompression of said compressed format.
